(19) United States
(12) Patent Application Publication
(10) Pub. No.: US 2003/0023989 A1
(43) Pub. Date: Jan. 30, 2003

(54) Method for visual display of broadcast audio-visual programmes and associated visual display device

(76) Inventors: Louis Chevallier, La Meziere (FR); Michel Cosmao, Liffre (FR)

Correspondence Address: Joseph S Tripoli, Thomson Multimedia Licensing, PO Box 5312, Princeton, NJ, 08543-0028, US

(21) Appl. No.: 10/220,158

(22) PCT Filed: Feb. 19, 2001
(86) PCT No.: PCT/FR01/00480

(30) Foreign Application Priority Data
Feb. 25, 2000 (FR) 00 02409

(51) Int. Cl. H04N 7/16

(52) U.S. Cl. 725/153

(57) ABSTRACT

The invention consists of a process for displaying audiovisual transmissions recorded in a digital television receiver. The process is characterized in that it consists in configuring a sequential list of transmissions and, in displaying the elements recorded in an order defined during configuration. Advantageously, the invention takes into account the updating the new versions of the transmissions.

The invention consists also of a digital television receiver comprising a memory for recording transmissions and a means of displaying for displaying them in a determined order.

The invention relates to the broadcasting and reception of audiovisual transmissions broadcast by a transmitter and more especially to a process for displaying, and a device for acquiring, storing and displaying audiovisual transmissions.

The invention applies more particularly to digital television receivers/decoders, more simply referred to as “decoders” hereinbelow. The network broadcasts audiovisual transmissions more commonly referred to as “events” and data intended for referencing them. These data are for example defined in the DVB-SI specifications (“Digital Video Broadcast—specification for Service Information”) EN 300 468 V1.3.1 (published by the ETSI). They take the form of tables and of descriptors which describe the objects transmitted on the broadcasting network. A service is an uninterrupted series of events broadcast on a specified stream.

Typically, the streams in accordance with the DVB-SI standard contain the following tables: NIT, SDT, EIT and possibly BAT. The NIT table defines the general structure of the network and indicates the list of transport streams and services broadcast. The SDT table gives additional information relating to the services, for example the unencrypted name of a service. The EIT table indicates a list of events for each service. It makes it possible in particular to indicate the event currently being broadcast. For its part, the BAT table clusters together several services into a bouquet of services which can be output by several broadcasting networks.

With the aid of the data contained in these tables, the decoder is capable of searching for the stream which is broadcasting the event desired by the user. A piece of software called the “Electronic Program Guide” (EPG for short) displays the characteristics of the events broadcast such as the title, the topic, a summary, the time of broadcast. It thus facilitates the user's choice.

Should the user be absent, the decoder can record the event. For this purpose it is furnished with a hard disk which stores the audiovisual transmissions in a compressed format. A menu subsequently makes it possible to display the content of the memory.

A system for recording audiovisual transmissions with the aid of a PC is described in International patent application WO97/36422. This system uses a PC as a means of controlling a video recorder for storing transmissions. A table displayed on a screen presents the user with the various recordings made. The user can then choose the one which he wishes to see. Another recording system is described in European patent application EP 942 600. This system exhibits the particular feature of recording the transmissions on an optical disk. The system contains a table making it possible to determine the address on the disk of the various transmissions recorded.

These various systems show that with the increasing memory capacity of receivers of audiovisual transmissions, the user can record more and more events. Hence, the step of selecting from the list of events in memory becomes lengthy. It is therefore important to optimize it.

The subject of the invention is a process for displaying audiovisual transmissions, said transmissions having previously been broadcast from a broadcasting center, received in a digital television receiver and recorded in a memory associated with said receiver, characterized in that it comprises within the receiver a step of configuring a sequential list of transmissions and a step of displaying the transmissions recorded in the order defined during the configuring step.

Thus, the invention enables the user to directly display the events recorded without compelling him to select each recording each time. The selection is performed beforehand in the course of a configuring step and remains active for all the displaying requests up to the next configuring step. The invention makes it possible to create truly customized channels where the displaying of the recordings is performed according to a sequencing complying with the preferences of a user. A customized channel can correspond to a user. It is also possible to configure a customized channel for a category of user, children for example, or for a specified object, films for example, or else in order to display only short events, advertisements for example.

The subject of the invention is also a receiver of digital audiovisual transmissions comprising a means for receiving data broadcast from a network and including at least said audiovisual transmissions and identifiers of said transmissions, a means for recording the data received by said receiving means, and a memory for recording said audiovisual transmissions, characterized in that said memory furthermore contains elements for sequential chaining of the recordings, and in that said receiver comprises a means of display displaying the transmissions recorded in the order determined by the chaining elements.

According to one embodiment, the displaying of the recordings is facilitated by navigation means associated with user commands such as: fast forward, fast rewind, displaying of the next recording, displaying of the previous recording.

Other characteristics and advantages of the present invention will emerge from the description of the exemplary embodiments which follow, taken as nonlimiting examples, with reference to the appended figures in which:

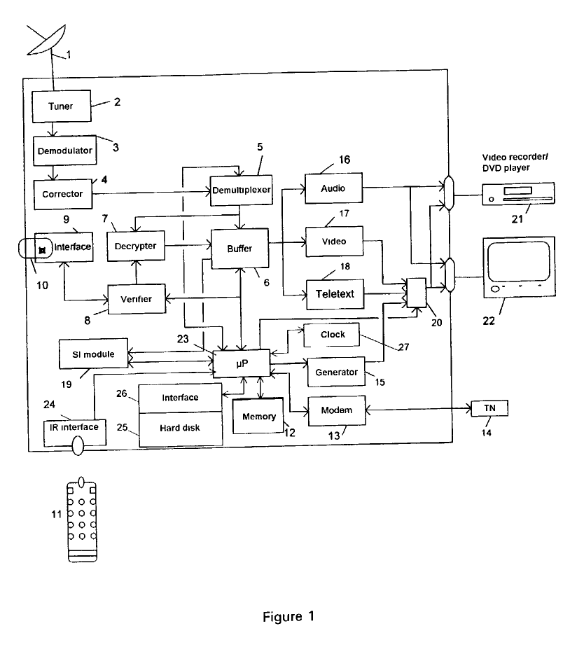

FIG. 1 represents a decoder implementing the invention,

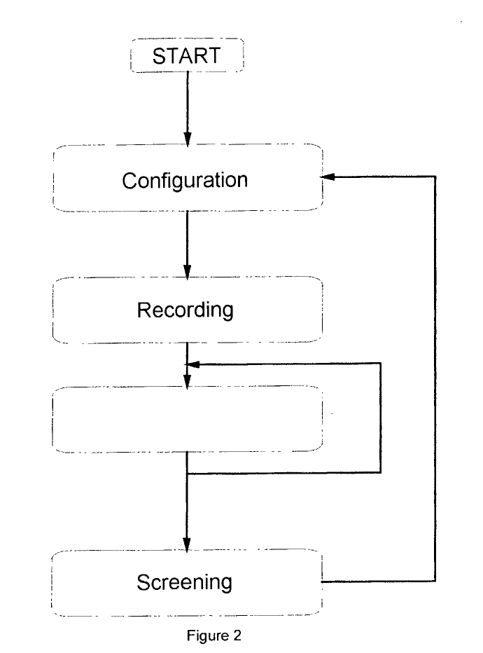

FIG. 2 represents a flowchart of the various steps of the process according to the invention

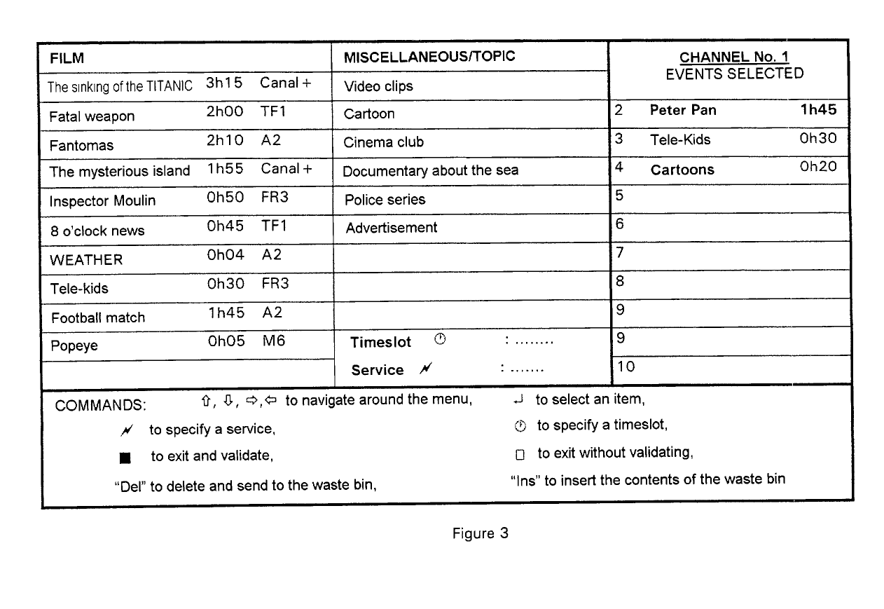

FIG. 3 shows a menu for configuring a customized channel,

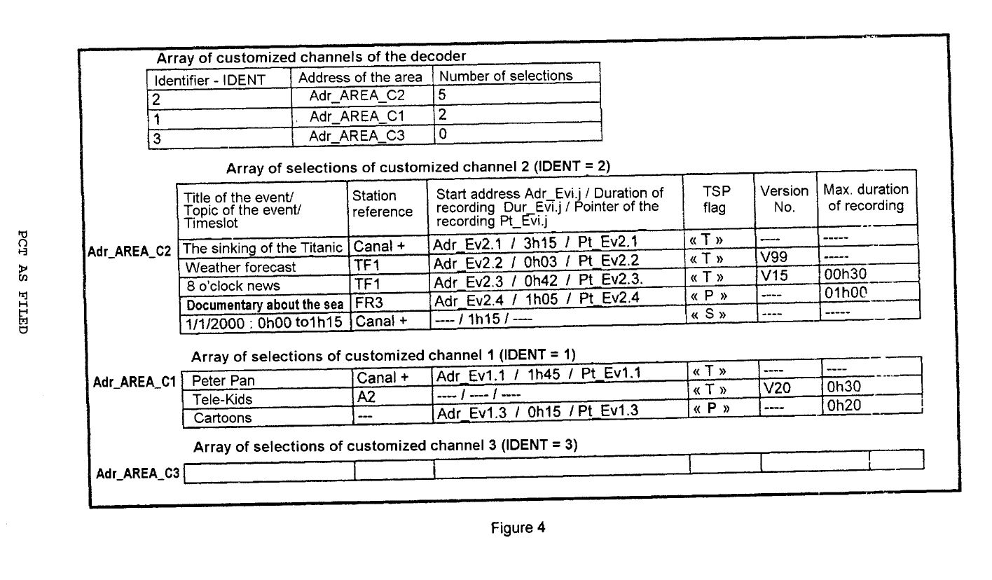

FIG. 4 represents the content of a part of the memory according to the invention,

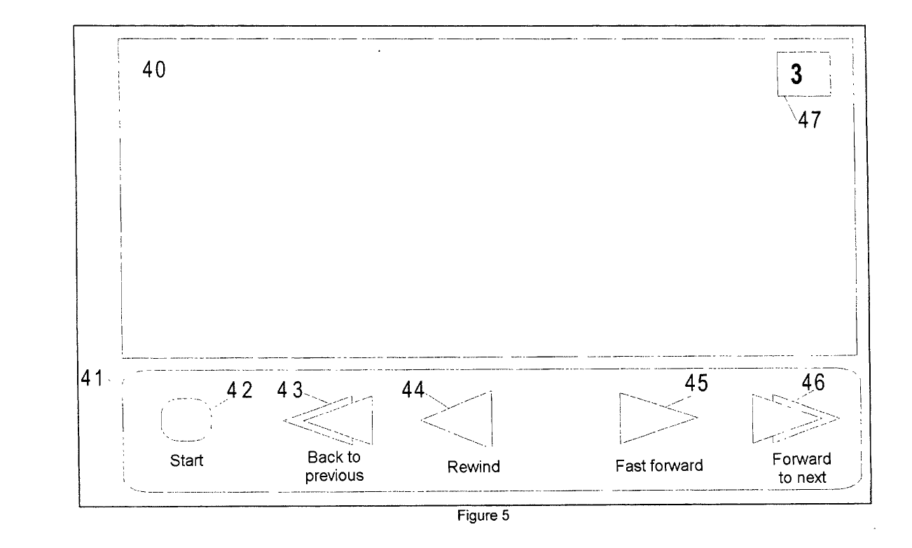

FIG. 5 shows a memory for displaying a customized channel,

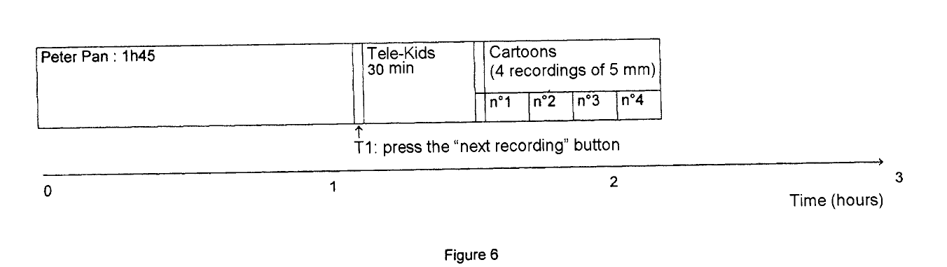

FIG. 6 is a timing diagram of the displaying of recordings.

A decoder according to the invention will firstly be described. Next, as represented by FIG. 2, the various steps of the invention will be described, namely: a step of configuring a customized channel, a step of recording the selected events, a step of updating certain so-called “recurrent” recordings and a step of displaying the recordings.

A receiver according to the invention is described in FIG. 1. The receiver is, for example, a decoder in accordance with the DVB specifications. It uses an ISO/IEC 13818-1 transport layer.

The receiver is linked to an antenna 1, itself linked to a tuner of the decoder. The signal provided by the tuner is demodulated by a demodulator 3. The demodulated data are deinterlaced and corrected by an error correcting circuit 4 and sent to a demultiplexer 5. The latter comprises a certain number of filters programmed by a microprocessor 23 as a function of the various applications supported by the receiver. The microprocessor 23 is connected to a memory 12 comprising the operating system as well as the resident or downloaded programs for implementing applications such as an EPG. The memory is illustrated in the form of a single block, but physically may comprise several blocks of different kinds; random access memory RAM, read only memory ROM, reprogrammable memory EEPROM or FLASH. The microprocessor is also connected to a clock circuit 27. A character generator 15 allows the generation of control or graphics menus relating to the parameters of the receiver or to a particular application. The video signal generated is multiplexed with one of the video signals originating from the video decoder 17 to a SCART socket linked to a television 22. The multiplexing circuit 20 is managed by the microprocessor 23. For the clarity of the diagram, only the most important connections of the microprocessor 23 are illustrated.

The audio or video sections or packets filtered by the demultiplexer are stored in predefined areas of a buffer memory 6. The receiver also comprises a hard disk 25 linked to the microprocessor with the aid of an interface 26 allowing fast transfers of information. The hard disk is advantageously integrated with the decoder, it can be proposed in the form of a separate piece of equipment. The support of the disk may possibly be removable. The capacity of the disk makes it possible to record at least several hours of audiovisual transmissions in a compressed format (MPEG 2 for example). The receiver is also fitted with a remote control 24, linked to the microprocessor by an infrared link. This remote control is fitted with buttons specific to the management of a customized channel, among other things it possesses the “CHANNEL CONFIGURATION” and “CHANNEL READ” buttons.

Initially, the user specifies his choices in the course of a step of configuring his customized channel. The user runs the configuration software with the aid of the CHANNEL CONFIGURATION button of his remote control or by selecting a function from a work menu. Initially, the software asks the user to enter a customized channel identifier “IDENT”. This identifier is a digit from 0 to 9, 2 for example. After validating the identifier, the configuration software displays on the screen of the television the configuration menu represented in FIG. 3. This screen prompts the user to select events announced in the EIT tables. In an especially advantageous manner, the displaying of the events is performed with the aid of an Electronic Program Guide (EPG for short). An EPG is a piece of software which analyzes the tables broadcast according to the standards of DVB-SI and extracts information which provides the user with particulars regarding the various current or forthcoming events.

The EPG presents the events in a menu by indicating the title, the duration and the service broadcasting the event. The user navigates around this menu with the aid of the buttons of his remote control corresponding to the arrows: ←, →, ↓ and ↑. He thus positions the cursor on the desired event and presses the “validate” button in order to select it. The EPG also presents topics of events that the use can select, for example: “documentary about the sea”, “cartoon”, “advertisement” or “police series”. The user can also specify an event in the form of a timeslot of a specified service. He then selects the “Timeslot/Service” option and manually enters into his remote control the day, time and station of his choice. In all cases and optionally, he can program the duration of the recording by pressing a function button.

The selections are displayed in the right-hand column, a serial number is assigned to each selection. At the start, the configuration software displays the list of selections made during the previous execution. Advantageously, the screen indicates whether the event selected has been recorded (selection in bold) and its actual duration and whether the event is currently being recorded (flashing). When the user navigates around his list of selections, additional functions are offered to him such as: delete a selection, move a selection, modify a selection, etc. Each shifting of an element of the list causes a renumbering of the elements within the customized channel, and optionally, a freeing up of the memory room occupied by a recording following a request to delete the corresponding selection. A delete command performed just after entering the identifier of a customized channel causes its removal and the freeing up of the entire memory area occupied by its data. Finally, a function enables the user to close the list of his selections. The software then terminates its execution by updating the nonvolatile memory with the data emanating from the configuring step.

In the example illustrated by FIG. 3, the customized channel 1 comprises the following selections: first “Peter Pan” (the selection is recorded, duration: 1 h 45), second “The tele-Kids” (the selection is not recorded, the duration displayed is that desired by the user), third, cartoons (the selection is currently being recorded, the user has requested 20 minutes).

In a first embodiment, the user presses specific buttons so as to execute the commands, the buttons being for example on his remote control. Another mode consists in the screen displaying a strip furnished with icons corresponding to the various functions which the user activates by selecting them with the aid of the arrows of his remote control and of a “VALIDATE” button.

The data emanating from the configuration step are stored in the arrays represented in FIG. 4. A first array called the “channels array” indexes the data areas reserved for each customized channel. This first array contains triples comprising: the customized channel identifier (in the example: a digit from 0 to 9), the address of the array containing the data of this channel and the number of events selected for this channel.

The other arrays called “selections array” or TAB-Ci contain the reference data for the selections of a channel. The array possesses the following fields:

event identifier,

station identifier,

programmed duration of the event,

Title/Slot/toPic (TSP) flag,

addressing and recording data.

The data in the selections array are stored in the order specified by the user. The index of the element in the array constitutes a serial number. As a variant, the array contains another column indicating the serial number, the elements can then be registered in any order. It is also possible to use a chained structure: each element of the array specifies the reference of the next element and of the previous element.

The event identifier is either its title, or its identification number in respect of the broadcaster (8-byte number for example) or a topic of transmission, or a combination of a reference of a service and of a timeslot. The choice between these three possibilities is determined by the state of the TSP flag. This flag takes the value “T” if the event is selected via its title, “S” if the event is selected via its timeslot on a specified service, “P” if the event is selected via its topic. The duration of recording of the event is optional, the value in this field is initialized to “0000” and remains at this value if the user does not use this option. The addressing and recording data are:

the start address of the recording “Adr_Evi.j”,

the value of the pointer at the moment of recording “Pt_Evi.j”,

the duration of the recording “Dur_Evi.j”,

optionally, a version number for the event.

The configuration software creates as many selections arrays as there are customized channels. FIG. 4 presents the arrays for three customized channels, one of which (number 3) does not yet contain any selections.

The step of configuring a customized channel having terminated, the decoder runs a routine for programming the demultiplexer so as to detect the appearance in the streams of the various events selected and undertake the recording thereof in the hard disk of the decoder. If the event is selected via the title or the topic, the data supplied by the tables of the DVB-SI supply the programming routine with the information (service number, time of broadcasting) enabling it to be searched for. If the event is selected via a timeslot, the decoder programs its clock with the start time of this timeslot. At the determined moment, it records the data transmitted in the service specified by the user.

The recording of an event in a hard disk is performed according to a well-known technique which therefore need not be described. The recording is performed starting from the address (Adr_Evi.j) determined at the start of the recording by the hard disk management software, this software being integrated into the interface 26. If the value Adr_Evi.j is zero, the event is not recorded. The events being multiplexed, pointers (Pt_Evi.j) define the address for writing in the course of recording. When the event is fully recorded, the value of the pointer is initialized to that of ADR_Evi.j. If the value is not zero, and if the value of Pt_Evi.j is different from that of Adr_Evi.j, then the event is currently being recorded.

The duration of the recording is specified by the user. If he does not do so, the duration is that of the event broadcast. If the user specifies an event via its title or its topic and should the duration which he specifies exceed the duration of a first recording, the decoder can record at least the start of a second event corresponding to the criteria. For example, if the user requests 20 minutes of recording of “cartoons” and if the broadcasts of such events last 5 minutes, the decoder can record 4 events corresponding to this topic. Advantageously, the memory area configured to record the duration specified by the user is managed cyclically. Thus, the memory always contains the latest events broadcast corresponding to the user's choices. At the end of each recording, the version number, if it exists, and the actual duration of the recording (Dur_Evi.j) are written to the array.

The updating of a recording is performed when the corresponding event is recurrent. The broadcaster of audiovisual transmissions supplies an indication of the recurrence or otherwise of the event in a specific field. If it is recurrent, it is associated with a version number which changes each time the content of the event alters. In this case, during each recording, the version number is updated in the selections array.

The events are customarily broadcast several times identically according to the carousel technique. If an event is not recurrent, it is recorded only during the first broadcast received by the decoder. After the recording of this event, the demultiplexer is programmed to disregard new broadcasts. If an event is recurrent, the decoder compares the version number broadcast with that registered in the selections array. If an event whose identifier corresponds to that of a recording but whose version is different from that recorded is broadcast, it must then be recorded. In this case, the event previously in memory is deleted and the version value in the selections array is updated. Such is the case for example with the “8 o'clock news” or “weather forecasts” as shown by the array in FIG. 4.

If the selection was made via a timeslot, the event broadcast at this moment is regarded by the decoder as having no version.

In order to display the content of a customized channel, the user presses the “CHANNEL READ” button, thereby running the displaying software. The software displays on the screen a menu presenting all the channels available in the decoder while itemizing for each channel the number of selections for which there is an available recording in memory. The user selects a channel, the screen represented in FIG. 5 is then displayed. This screen comprises two elements: the first recording of the list of selections, displayed on the upper part of the screen (40) and a function strip (41) appearing at the bottom of the screen. This strip comprises five icons corresponding to the basic functions. The first (42) enables the user to display the first recording of the customized channel. The second (43) and the fifth (46) make it possible to select or to display the recording which precedes or follows the one currently in the list of selections. The third (44) and the fourth (45) make it possible to go backward and forward faster. Other functions which are not represented in FIG. 5 are also possible such as image freeze, muting, access to interactivity elements stored at the same time as the recording, etc.

Just like for the configuring step, a first mode of embodiment consists in the remote control being fitted with function buttons. A second mode comprises the activation of the functions with the aid of icons selected on the screen with the aid of the arrows and the “VALIDATE” button.

The number of the recording (47) currently being displayed appears in the top left of the screen. The number and the strip may disappear by pressing a function button.

The displaying software operates in the following manner. Once the user has typed in the identifier IDENT, the software searches the array for the value of IDENT and obtains the address Adr_AREA_Ci and the number of selections of this channel. It initializes a variable represented by a register in work memory called “NUM” with the value “1”. This variable represents the serial number of the selection currently being displayed. If the user has so requested, this variable is displayed on the screen. The software then searches through the selections array for the address and the duration of the first recording. It initializes a pointer for reading the recording with the address value ADR_Evi.j, and displays the data read. If the software receives a command corresponding to the icons 43 or 46, it reads the next element or the previous recording in the array and displays the corresponding recording. In this way, it adds a unit to the variable NUM or deducts one from it. If the software receives a command corresponding to the icons 43 or 44, reading is speeded up or the value of the pointer is decreased thereby allowing fast reverse displaying of the recording. If the software receives the command corresponding to the icon 42, it repoints to the first recording of the list of selections.

FIG. 6 shows the displaying of customized channel number 1 over time. At the moment labeled T1, the user has selected the command for reading the next recording, thereby cutting short the displaying of the film “Peter Pan” and immediately bringing up the start of the transmission “the Tele-Kids”. Lastly, four cartoons are displayed for a total duration of 20 minutes. At the end of the 20 minutes, the screen again displays the first recording: Peter Pan.

As a variant, the decoder being furnished with a bidirectional link which allows it to connect up to a network, it can download video sequences from the network. These sequences are recorded in the hard disk with the aid of a downloading routine. They appear in the configuration menu with a distinctive element. It is also possible to select a timeslot by specifying a network address instead of a service reference. At the time indicated, the decoder sets up a connection to the indicated address and downloads the sequence. If the reference of the service is a URL (“Universal Resource Locator”) this video sequence may for example be an HTML page.

The invention is of course not limited to the embodiments just described. In particular, the technology of the memory of the recordings can be optical (recordable CD-ROM, DVD-ROM for example), magnetic (cartridge), or an equivalent technology.

1. A process for displaying audiovisual transmissions, said transmissions having previously been broadcast from a broadcasting center, received in a digital television receiver and recorded in a memory associated with said receiver, characterized in that it comprises within the receiver a step of configuring a sequential list of transmissions and a step of displaying the transmissions recorded in the order defined during the configuring step.

2. The process for displaying audiovisual transmissions as claimed in claim 1, characterized in that the configuring step consists in assigning a serial number to each transmission of the sequential list.

3. The process for displaying audiovisual transmissions as claimed in claim 1 or 2, characterized in that the configuring step comprises a step of presentation to the user of the identifier of at least one plurality of data whose broadcasting is announced, a step of selection by the user of a set of data within the plurality, and a step of creating the sequential list of transmissions.

4. The process for displaying audiovisual transmissions as claimed in claim 1 or 2, characterized in that the displaying step comprises the following successive steps:
displaying of a recorded transmission,
detection of a command supplied by the user,
in response to said command, search for a transmission situated sequentially just before or just after the one displayed,
displaying of the transmission found.

5. The process for displaying audiovisual transmissions as claimed in claim 1 or 2, characterized in that said transmissions are referenced by an identifier and an update indicator, and in that it furthermore comprises a step of recording in memory the identifier and the update indicator, which step is activated during the recording of the broadcast transmission, and a step of recording a broadcast transmission, which recording is referenced by the same identifier and the value of whose update indicator is different from the value of the broadcast transmission.

6. The process for displaying audiovisual transmissions as claimed in claim 5, characterized in that the update indicator is a version number given by the broadcasting center.

7. The process for displaying audiovisual transmissions as claimed in claim 3, characterized in that the selection of the data is performed via the title of a broadcast data item, via a topic or via a timeslot associated with a service reference.

8. The process for displaying audiovisual transmissions as claimed in any one of the preceding claims, characterized in that the configuring step contains a step of entering a sequential list number.

9. A receiver of digital audiovisual transmissions comprising a means for receiving data broadcast from a network and including at least said audiovisual transmissions and identifiers of said transmissions, a means for recording the data received by said receiving means, and a memory for recording said audiovisual transmissions, characterized in that said memory furthermore contains elements for sequential chaining of the recordings, and in that said receiver comprises a means of display displaying the transmissions recorded in the order determined by the chaining elements.

10. The receiver of audiovisual transmissions as claimed in claim 9, characterized in that it furthermore comprises a means of display of the identifier of at least one broadcast transmission, and a means of selection by the user of at least this identifier with a view to the recording of the transmission in the sequential list of recordings.

11. The receiver of audiovisual transmissions as claimed in claim 9, characterized in that it furthermore comprises a means of detection of the variation of a value of update indicator, said means of detection triggering a means of updating the recording.

12. The receiver of audiovisual transmissions as claimed in claim 9, characterized in that it furthermore comprises a means of entry of a maximum duration of recording and in that the means of recording stops when a maximum duration of recording is reached.

13. The receiver of audiovisual transmissions as claimed in claim 9, characterized in that it furthermore comprises a means of selection of the recording preceding or succeeding the one currently being displayed, said means of selection triggering the displaying of the selected recording.

14. The receiver of audiovisual transmissions as claimed in any one of claims 9 to 13, characterized in that the chaining element comprises a serial number associated with each recording.

15. The receiver of audiovisual transmissions as claimed in claim 14, characterized in that it comprises a means of display of the serial number of the recording currently being displayed.
